(19) United States
(12) Patent Application Publication
(10) Pub. No.: US 2012/0126548 A1
(43) Pub. Date: May 24, 2012

(54) RETRACTABLE NOISE REDUCTION LOCKING SHOE ASSEMBLY FOR WINDOWS OR DOORS

(76) Inventor: Xiao Lu Zhuo, Toronto (CA)

(21) Appl. No.: 12/953,250

(22) Filed: Nov. 23, 2010

(51) Int. Cl. E05C 1/10

(52) U.S. Cl. 292/169

(57) ABSTRACT

A retractable noise reduction locking shoe assembly for locking a horizontal or vertical sash window or door within a channel of frame includes a slide block with a primary opening extending from a front side of slide block to a rear side of slide block. Slide block has opposing side openings in communication with primary opening. A retractable side block is slidably received within each of the opposing side openings. A pair of spring members is oppositely disposed within a partial channel. Spring members are adapted to receive retractable side block within each of the opposing side openings. A cam with a front side defined by a perimeter and a rear side defined by a variable diameter having first and second ends, the second end configured to receive a pivot member mounted on either sash window or door. Cam is disposed within primary opening and adapted to be rotatable by pivot member.

### TECHNICAL FIELD

The present invention relates to the field of locking shoes for windows or doors, and more specifically to an improved locking shoe assembly for locking a horizontal or vertical sash window or door within a channel of a frame.

### BACKGROUND OF THE INVENTION

Conventional double-hung and slider windows have vertical and horizontal sliding sash windows that can be pivoted or tilted out of the frame as desired. These types of windows have gained widespread popularity for their convenience in cleaning the outside of the window from the inside or for replacing a broken screen or pane on the outside from the inside.

Various types of locking or pivot mechanisms for such types of sliding sash windows have heretofore been available. Some of the problems associated with these conventional locking mechanisms include inadequate locking strength and reliability, susceptibility to being dislodged from channel when downward pressure is applied, tendency to cut into and damage profile, and unpleasant audible “pop” sound when the sash window or door is closed, among others.

In view of the above, there exists a need for a locking shoe assembly that increases the locking power and force of the horizontal or vertical sash window or door within the channel of the frame without cutting into and damaging the profile of the frame. There is a further need for a locking shoe assembly with noise reduction capabilities such that the unpleasant audible “pop” sound of conventional locking mechanisms is not heard when the sash window or door is opened or closed within the channel of the frame.

### SUMMARY OF THE INVENTION

In a first aspect, there is provided herein a retractable noise reduction locking shoe assembly for locking a horizontal or vertical sash window or door within a channel of a frame. The locking shoe assembly includes a slide block having a primary opening extending from a front side of the slide block to a rear side of the slide block. The slide block has opposing side openings in direct communication with the primary opening, the primary opening from the front side of the side block is defined by at least a partial channel. The locking assembly further includes a retractable side block having a first end and a second end slidably received within each of the opposing side openings. The locking assembly includes a pair of spring members having a first end and a second end oppositely disposed within the partial channel. The first end of the spring member and the second end of the spring member are adapted to receive each retractable side block first end and second end within each of the opposing side openings. The locking assembly includes a cam having a front side defined by a perimeter and a rear side defined by a variable diameter having a first end and a second end, the second end configured to receive a pivot member mounted on either the sash window or door. The cam is rotatably disposed within the primary opening and adapted to be rotatable by the pivot member.

Rotation of the cam to an open position invokes a portion of the cam rear side other than the first end and the second end of the cam rear side to come into contact with each of the retractable side blocks to urge the retractable side blocks at opposing side openings to expand outwardly from the slide block and lock the slide block within the channel of the window or door frame. Rotation of the cam to a closed position invokes the first end and the second end of the cam rear side to come into contact with each of the retractable side blocks to urge the retractable side blocks at opposing side openings to retract inwardly from the slide block and unlock the slide block within the channel of the window or door frame.

In certain embodiments, the slide block is formed by injection molding.

In certain embodiments, the retractable side block includes a plurality of serrations.

In certain embodiments, the serrations may be comprised of an array of geometric shapes.

In certain embodiments, the array of geometric shapes may include squares, circles, triangles, semi-circles, cones, zigzags, or v-shapes, or a combination thereof.

In certain embodiments, the retractable side block at each of the opposing side openings forms a plurality of dimples in the channel of the frame when the cam is rotated to the open position.

In certain embodiments, the plurality of dimples in the channel of the frame disappear when the cam is rotated to the closed position.

In certain embodiments, the first end and the second end of the pair of spring members are connected to the first end and the second end of the retractable side block at each of the opposing side openings.

In certain embodiments, rotation of the cam from the open position to the closed position creates an inaudible sound when the sash window or door is opened or closed within the channel of the frame.

In certain embodiments, the front side of the cam is flat.

In certain embodiments, the front side of the cam has longitudinal ridges disposed thereon.

In certain embodiments, the rear side of the cam includes a transverse base having a rectangular opening for receiving the pivot member.

In certain embodiments, the front side of the cam is configured to be in operative communication with the channel of the frame when the cam is rotated to the open position.

In certain embodiments, the first end and the second end of the cam rear side are separated from each other by no greater than about 180 degrees.

In certain embodiments, rotation of the cam by about 15 degrees to about 44 degrees from the closed position to the open position invokes the portion of the cam rear side other than the first end and the second end of the cam rear side to come into contact with each of the retractable side blocks to urge the retractable side blocks at opposing side openings to expand outwardly from the slide block and lock the slide block within the channel of the window or door frame.

In certain embodiments, rotation of the cam by about 44 degrees from the open position to the closed position invokes the first end and the second end of the cam rear side to come into contact with each of the retractable side blocks to urge the retractable side blocks at opposing side openings to retract inwardly from the slide block and unlock the slide block within the channel of the window or door frame.

In certain embodiments, rotation of the cam from the open position to the closed position invokes the first end and the second end of cam rear side to come into contact with each of the retractable side blocks at opposing side openings to retract inwardly from the slide block by a force of the pair of spring members and unlock the slide block within the channel of the window or door frame.

In certain embodiments, rotation of the cam by about 15 degrees to about 44 degrees from the closed position to the open position gradually increases the variable diameter of the cam rear side from about 17.00 mm to about 18.50 mm.

In certain embodiments, rotation of the cam by about 44 degrees to about 15 degrees from the open position to the closed position gradually decreases the variable diameter of the cam rear side from about 18.50 mm to about 17.00 mm.

In certain embodiments, the cam rear side is defined by a perimeter such that the first end and the second end of the cam rear side have a diameter that is less than the diameter of the remaining perimeter of the cam rear side.

In certain embodiments, the sash window or door is slidably connected to the frame through at least two retractable noise reduction locking shoes, which slide inside the channel of the frame when the cam is rotated to the closed position.

In certain embodiments, the rear side of the slide block includes an upper half portion comprised of a plurality of oppositely disposed protrusions.

In certain embodiments, the plurality of oppositely disposed protrusions may be individually ribbed.

In a second aspect, there is provided herein a retractable noise reduction locking shoe assembly for locking a horizontal or vertical sash window or door within a channel of a frame. The locking shoe assembly includes a slide block having a primary opening extending from a front side of the slide block to a rear side of the slide block. The slide block includes opposing side openings in direct communication with the primary opening, the primary opening from the front side of the side block is defined by at least a partial channel. The locking assembly further includes a retractable side block having a first end and a second end slidably received within each of the opposing side openings. The retractable side block has serrations comprised of an array of geometric shapes. The locking assembly includes a pair of spring members having a first end and a second end oppositely disposed within the partial channel. The first end of the spring member and the second end of the spring member are adapted to receive each retractable side block first end and second end within each of the opposing side openings. The locking assembly includes a cam having a front side defined by a perimeter and a rear side defined by a variable diameter having a first end and a second end, the second end configured to receive a pivot member mounted on either the sash window or door. The cam is rotatably disposed within the primary opening and adapted to be rotatable by the pivot member.

Rotation of the cam to an open position invokes a portion of the cam rear side other than the first end and the second end of the cam rear side to come into contact with each of the retractable side blocks to urge the retractable side blocks at opposing side openings to expand outwardly from the slide block and lock the slide block within the channel of the window or door frame. Rotation of the cam to a closed position invokes the first end and the second end of cam rear side to come into contact with each of the retractable side blocks to urge the retractable side blocks at opposing side openings to retract inwardly from the slide block and unlock the slide block within the channel of the window or door frame. Rotation of the cam from the open position to the closed position creates an inaudible sound when the sash window or door is opened or closed within the channel of the frame.

Various advantages of this invention will become apparent to those skilled in the art from the following detailed description of the preferred embodiments, when read in light of the accompanying drawings.

### BRIEF DESCRIPTION OF THE DRAWINGS

FIG. 1 is a front perspective view of a double-hung vertical window with the lower window sash in a tilted position incorporating the locking shoe assembly of the present invention;

FIG. 2 is a front perspective view of a slider horizontal window with the left window sash in a tilted position incorporating the locking shoe assembly of the present invention;

FIG. 3 is an exploded perspective view of the locking shoe assembly of the present invention;

FIG. 4 is an outer perspective view of the slide block of the locking shoe assembly of the present invention;

FIG. 5 is an inner elevation view of the slide block of the locking shoe assembly of the present invention shown with the cam removed;

FIG. 6 is a perspective view of the cam of the locking shoe assembly of the present invention;

FIG. 7 is a perspective view of a pivot bar contained within the cam mechanism of the locking shoe assembly of the present invention shown in an open or locked position;

FIG. 8 is an enlarged elevation view of the locking shoe assembly shown in a closed or unlocked position;

FIG. 9 is an enlarged elevation view of the locking shoe assembly shown in an open or locked position;

FIGS. 10A-10F illustrate exemplary configurations of the retractable side block of the locking shoe assembly of the present invention;

FIG. 11A is an enlarged perspective view of the first end of the cam rear side and the retractable side block, which contact each other when cam is in the closed position;

FIG. 11B is an enlarged perspective view of the second end of the cam rear side and the retractable side block, which contact each other when cam is in the closed position; and

FIG. 12 is an exemplary embodiment of the cam rear side in the closed to position.

### DETAILED DESCRIPTION OF THE INVENTION

The detailed description set forth below in connection with the appended drawings is intended as a description of preferred embodiments of the present disclosure, and is not intended to represent the only forms that may be developed or utilized. The description sets forth the various functions in connection with the illustrated embodiments, but it is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

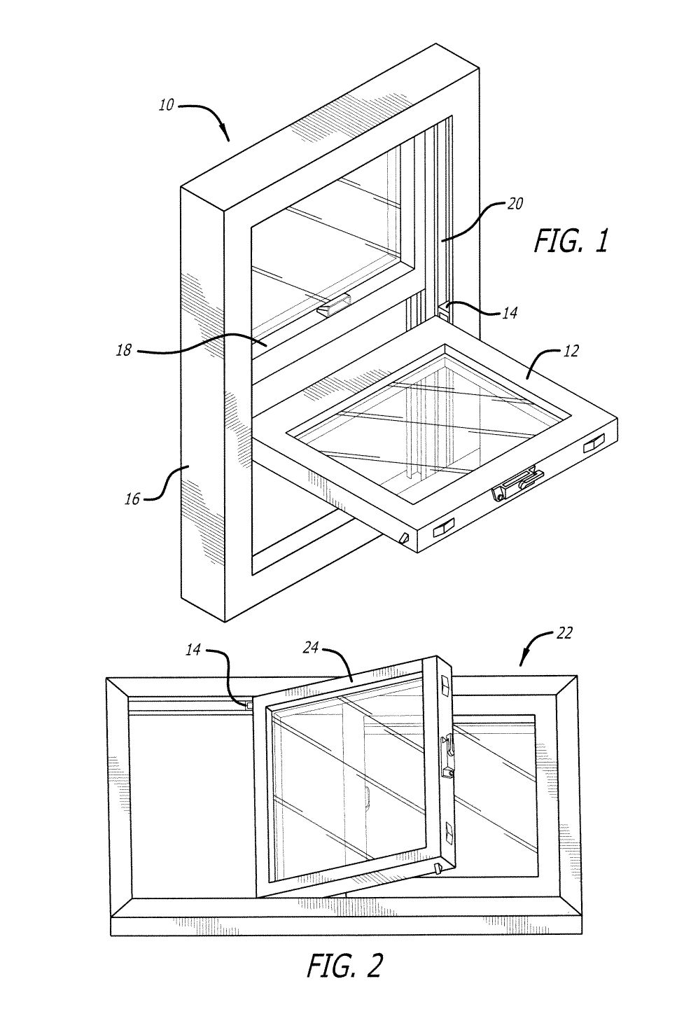

Referring now to the drawings, specifically, FIG. 1, there is depicted a front perspective view of a conventional double-hung vertical window 10 with the lower sash 12 in a tilted position incorporating the retractable noise reduction locking shoe assembly 14 of the present invention. The frame 16 of the window 10 incorporates window sashes 12, 18, which are slidably mounted within longitudinal channels 20 of the frame. The channels 20 are generally in a parallel orientation to one another in the frame 16 such that the window sashes 12, 18 slide vertically therein between closed and open positions. Each sash window 12, 18 has a locking shoe assembly 14 associated therewith on both sides of the respective sash and carried in the respective channel 20 in which the sash slides when in a closed or unlocked position. With a tilt of the sash 12, the locking shoe assembly 14 of the present invention is configured to lock itself in an open position as described in further detail below so as to maintain the sash 12 in a fixed position during cleaning, replacing of the pane, and the like.

FIG. 2 illustrates a front perspective view of a conventional slider horizontal window 22 with the left window sash 24 in a tilted position incorporating the locking shoe assembly 14 of the present invention. It is to be understood that the locking shoe assembly may also be a door assembly in which a slidable door is positioned within a door frame. It is to be further understood that the present invention is not limited to horizontally and vertically sliding sashes, but also may be used in conjunction with any other sliding member within a frame of a window or door.

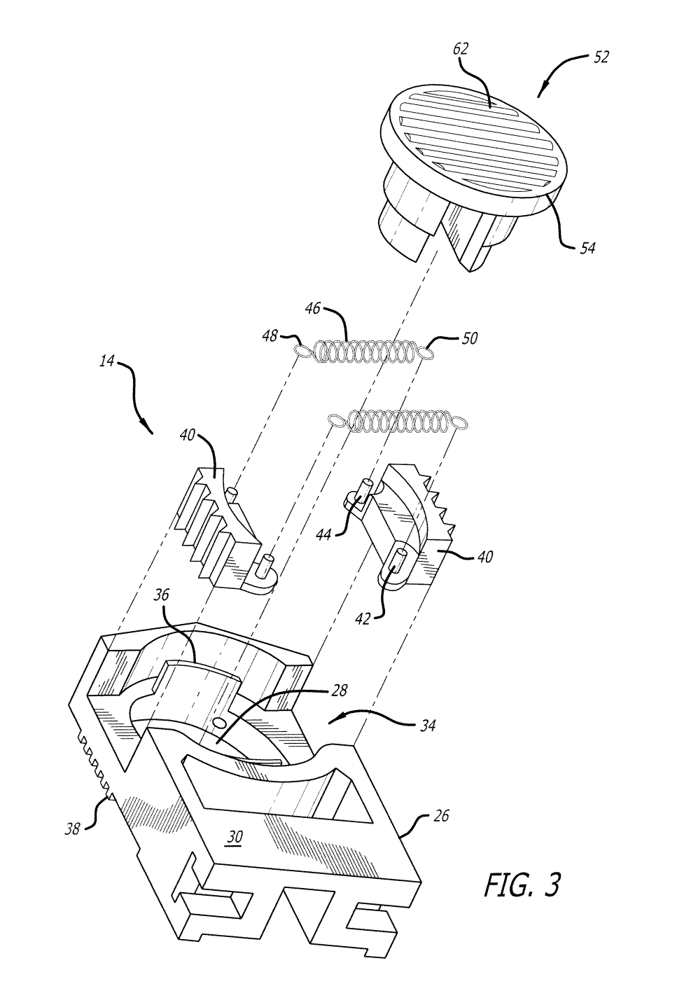

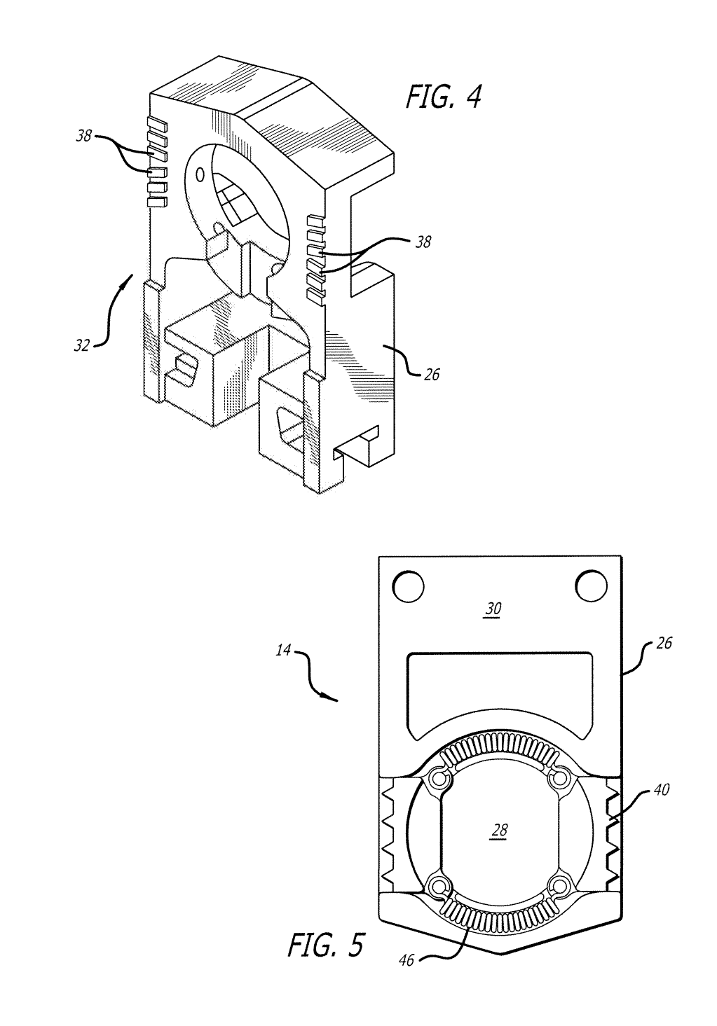

A detailed construction of the locking shoe assembly 14 of the present invention is shown in FIG. 3. The locking shoe assembly 14 includes a slide block 26 having a primary opening 28, which extends from a front side 30 of the slide block to a rear side 32 (FIG. 4) of the slide block. The slide block 26 is configured to have opposing side openings 34 in direct communication with the primary opening 28. The primary opening 28 is defined by at least a partial channel 36 disposed therein. The slide block 26 is preferably fabricated from an injection-molded plastic material and is smoothly finished on its outside surface. Rear side 32 (FIG. 4) of the slide block 26 may be configured to include a plurality of ribbed protrusions 38 oppositely disposed from one another. It is to be understood that the protrusions 38 on the rear side 32 of the slide block 26 can be configured to assume various shapes and are not limited to the individually ribbed protrusions 38 disclosed herein.

The locking shoe assembly 14 includes a pair of retractable side blocks 40 each having a pronged first end 42 and a pronged second end 44 slidably received within each of the opposing side openings 34 of the slide block 26. The retractable side blocks 40 may be fabricated from aluminum, zinc, or other suitable metal or metal alloy materials. The locking shoe assembly 14 further includes a pair of metal or metal alloy spring members 46 each having a first end 48 and a second end 50 configured to be oppositely disposed from one another within the partial channel 36. First end 48 of spring member 46 and second end 50 of spring member are adapted to receive each retractable side block 40 first end 42 and second end 44 within each of the opposing side openings 34 of the slide block 26. It is to be understood that the spring members 46 may be connected to first end 42 and second end 44 of the retractable side block 40 in various manners, such as by loop or latch and hook attachment, soldering, welding, and the like.

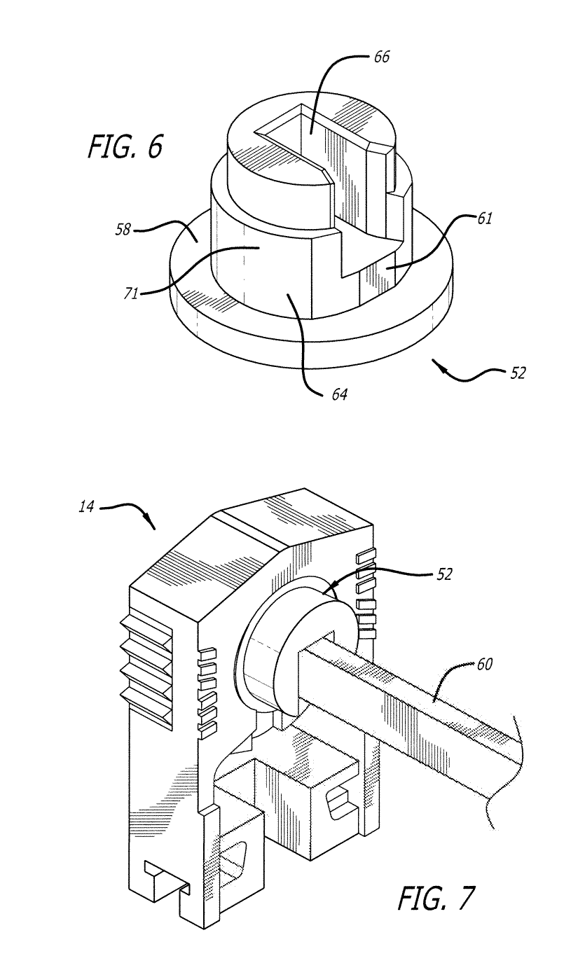

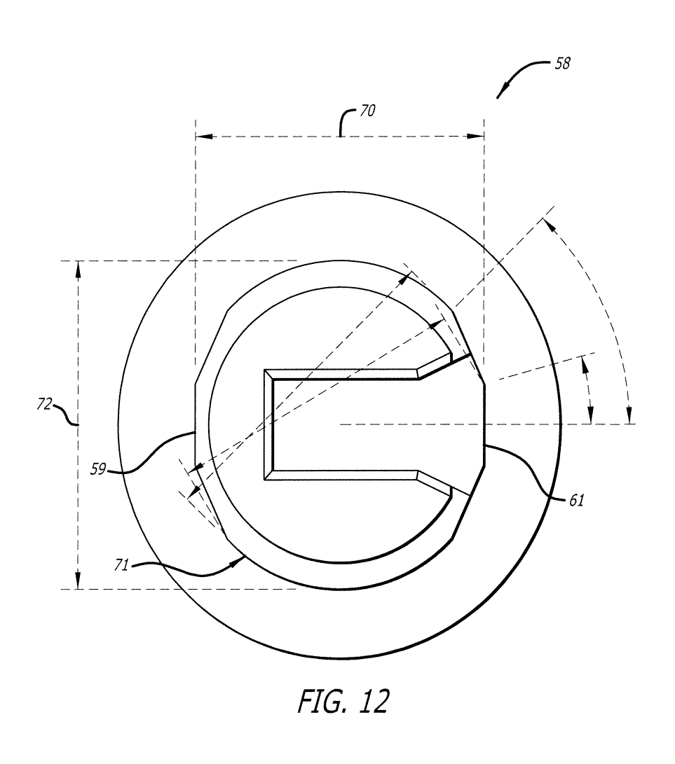

Referring further to FIG. 3, the locking shoe assembly 14 of the present invention includes a cam 52 having a front side 54 defined by a perimeter 56 and a rear side 58 defined by a variable diameter 70 (FIG. 12) having a first end 59 and a second end 61, the second end configured to receive a pivot member 60 (FIG. 7) mounted on either the sash window 12, 18 (FIG. 1) or door (not shown). In one embodiment, the first end 59 and the second end 61 of the cam rear side 58 are separated from each other by no greater than about 180 degrees. The cam rear side 58 is defined by a perimeter 71 (FIG. 12) such that the first end 59 and the second end 61 of the cam rear side have a diameter 70 that is less than the diameter 72 of the remaining perimeter of the cam rear side. The first end 59 and the second end 61 of the cam rear side 58 can be configured to be flattened (FIGS. 6, 11A-11B, and 12). The front side 54 of cam 52 is configured to be flat with longitudinal ridges 62 disposed thereon. The cam 52 is rotatably disposed within the primary opening 28 and adapted to be rotatable by pivot member 60.

In operation, rotation of cam 52 to an open position (FIG. 9) invokes a portion of the cam rear side 58 other than the first end 59 and the second end 61 of the cam rear side 58 to come into contact with each of the retractable side blocks 40 to urge the retractable side blocks at opposing side openings 34 to expand outwardly from the slide block 26 within the channel 20 of the window or door frame. The front side 54 of cam 52 is configured to be in operative communication with the channel 20 of the frame 16 when cam 52 is rotated to the open position. It is contemplated by the present invention that the retractable side block 40 at each of the opposing side openings 34 forms a plurality of dimples or otherwise slight indentations in the channel 20 of the frame 16 when cam 52 is rotated to the open position.

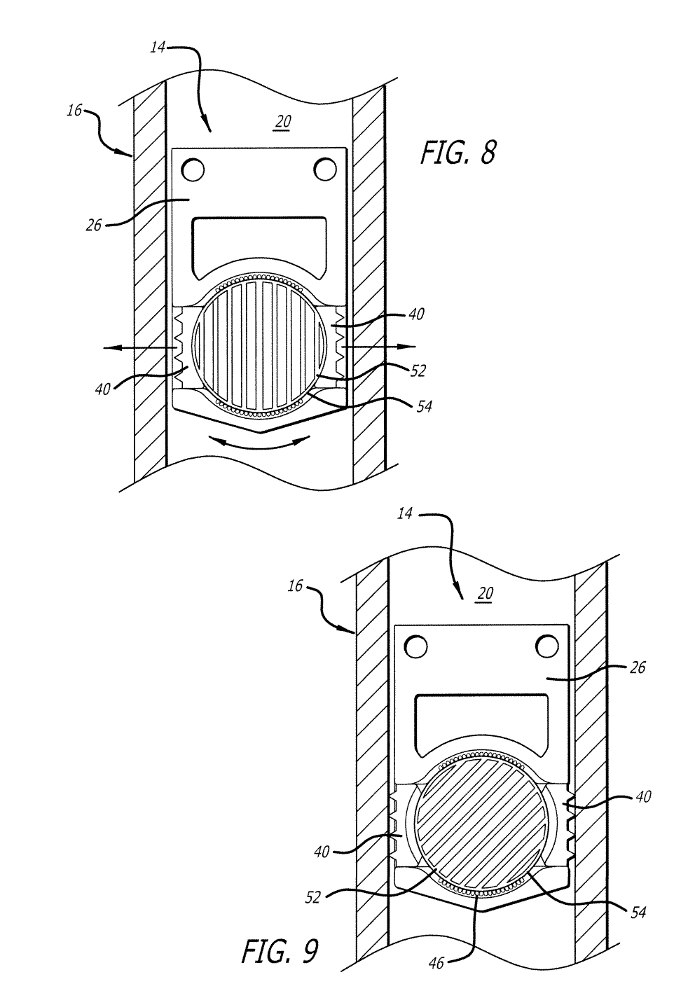

Rotation of cam 52 to a closed position (FIG. 8) invokes the first end 59 and the second end 61 of the cam rear side 58 to come into contact with each of the retractable side blocks 40 to urge the retractable side blocks at opposing side openings 34 to retract inwardly from the slide block 26 and unlock the slide block 26 within the channel 20 of the window or door frame. The force of the pair of spring members 46 retracts the side block 40 at each of the opposing side openings 40 when cam 52 is turned to the closed position. It is further contemplated by the present invention that the plurality of dimples in the channel 20 of the frame 16 disappear and the frame profile otherwise resumes its original appearance when cam 52 is rotated to the closed position.

In an exemplary embodiment, rotation of the cam by about 44 degrees to about 15 degrees from the open position to the closed position, the variable diameter 70 (FIG. 12) of the cam rear side 58 gradually decreases from about 18.50 mm to about 17.00 mm.

In another exemplary embodiment, rotation of cam 52 by about 15 degrees to about 44 degrees from the closed position (FIG. 8) to the open position (FIG. 9) invokes the portion of the cam rear side 58 other than the first end 59 and the second end 61 of the cam rear side to come into contact with each of the retractable side blocks 40 at opposing side openings 34 to expand outwardly from the slide block 26 and lock the slide block within the channel 20 of the window or door frame. Rotation of cam 52 by about 44 degrees from the open position (FIG. 9) to the closed position (FIG. 8) invokes the first end 59 and the second end 61 of the cam rear side 58 to come into contact with each of the retractable side blocks 40 to urge the retractable side blocks at opposing side openings 34 to retract inwardly from the slide block 26 by force of the pair of spring members 46 and unlock the slide block within the channel 20 of the window or door frame.

In a further exemplary embodiment, rotation of the cam by about 15 degrees to about 44 degrees from the closed position to the open position, the variable diameter 70 (FIG. 12) of the cam rear side 58 gradually increases from about 17.00 mm to about 18.50 mm.

In one embodiment, rotation of cam 52 from the open position to the closed position creates an inaudible sound when the sash window 12, 18 or door is opened or closed within the channel 20 of the frame 16.

FIG. 4 illustrates an outer perspective view of the slide block 26 of the locking shoe assembly 14 of the present invention. The outer or rear side 32 of the slide block 26 faces away from the channel 20 in the frame 16 when the locking assembly is appropriately mounted on the sash window 12, 18 by way of the pivot member 60.

FIG. 5 illustrates an inner elevation view of the slide block 26 of the locking shoe assembly 14 of the present invention with the cam 52 removed from the primary opening 28 of the slide block 26. The inner or front side 30 of the side block 26 faces the channel 20 in the frame 16 when the locking shoe assembly is appropriately mounted on the sash window 12, 18 by way of the pivot member 60.

FIG. 6 illustrates a perspective view of the cam mechanism 52 of the locking shoe assembly 14 of the present invention with the pivot member 60 removed. The rear side 58 of the cam 52 includes a transverse base 64 with a rectangular opening 66 for receiving the pivot member 60. It is to be understood that transverse base 64 may assume various shaped openings and is not limited to the rectangular opening 66 disclosed herein.

FIG. 7 is a perspective view of the pivot member 60 contained within the cam mechanism 52 of the locking shoe assembly 14 of the present invention shown in the open or locked position.

In accordance with the present invention, the window sash 12 is connected to the double-hung vertical window 10 or slider horizontal window 22 through the locking shoe assembly 14 inside the channel 20 of the window frame 16. In one embodiment, sash window 12, 24 or door (not shown) is slidably connected to the frame 16 through at least two locking shoe assemblies 14 (one at each end of sash window 12, 24 as shown in FIGS. 1 and 2), which slide inside the channel 20 of the frame 16 when cam 52 is rotated to the closed position (FIG. 8).

FIG. 8 is an enlarged elevation view of the locking shoe assembly 14 shown in the closed or unlocked position within the channel 20 of the frame 16. FIG. 9 is an enlarged elevation view of the locking shoe assembly 14 shown in the open or locked position within the channel 20 of the frame 16.

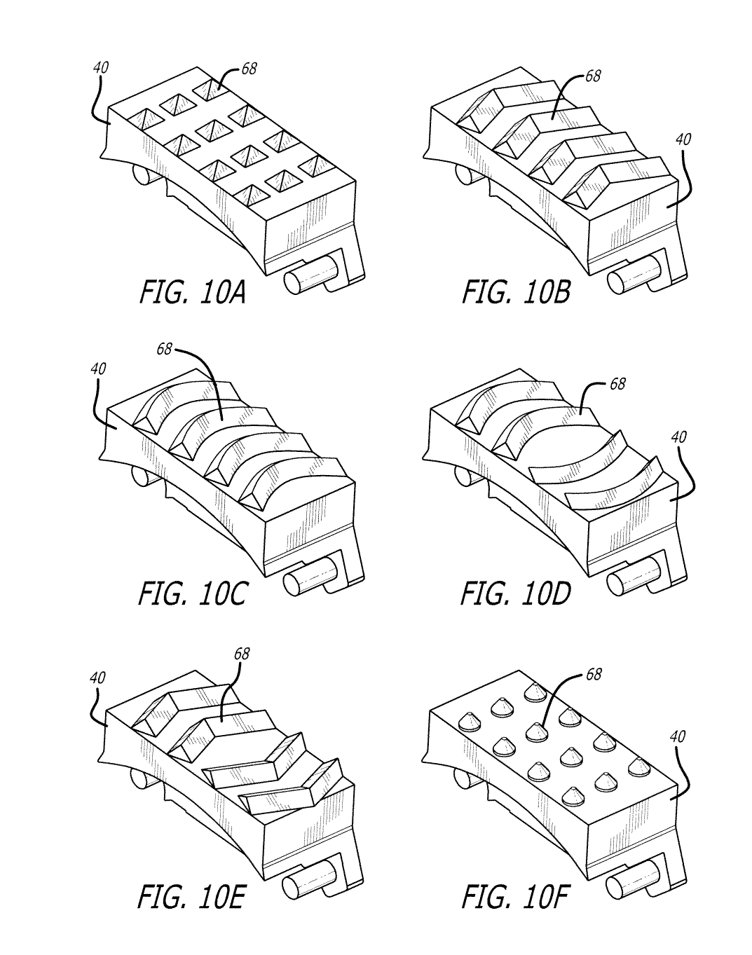

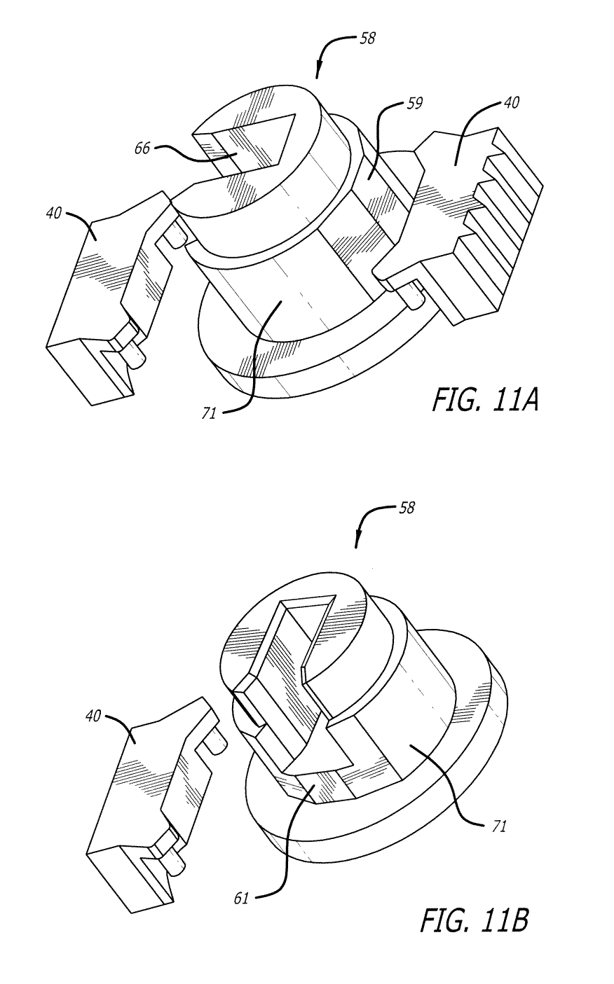

FIGS. 10A-10F illustrate exemplary configurations of the retractable side block 40 of the locking shoe assembly 14 of the present invention. In one embodiment, the retractable block 40 includes a plurality of serrations 68. The plurality of serrations 68 may be comprised of an array of geometric shapes. The array of geometric shapes may include squares, circles, triangles, semi-circles, cones, zigzags, or v-shapes, or a combination thereof. It is to be understood that various other shapes may be used in the design of the serrations 68 of the retractable block 40 and are not to be limited to the geometric shapes disclosed herein.

FIG. 11A illustrates an enlarged perspective view of the first end 59 of the cam rear side 58 (shown opposite the second end 61 with rectangular opening 66 for receiving pivot member 60) and the retractable side block 40, which contact each other when cam 52 is in the closed position. FIG. 11B is an enlarged perspective view of the second end 61 of the cam rear side 58 and the retractable side block 40, which contact each other when cam 52 is in the closed position.

Referring now to FIG. 12 is an exemplary embodiment showing the cam rear side 58 in the closed position. The variable diameter 70 of the cam rear side 58 gradually increases to diameter 72 as the cam is moved from about 15 degrees to about 44 degrees from the closed position to the open position. It is to be understood that the variable diameter 70, 72 of the cam rear side 58 and corresponding angles shown in broken lines are not limited to the specific measurements disclosed herein, but rather may assume a variety of ranges, as the specifications of the cam 52 for the locking shoe assembly of the present invention may be adjusted accordingly within the scope of the invention.

It can be appreciated that the locking shoe assembly of the present invention has several primary advantages over conventional locking shoe assemblies. Some of these primary advantages include increased locking power and force within the channel of the frame without cutting into and damaging the profile, spring-loaded cam mechanism steadily retracts the side blocks to inward position when cam is rotated to the closed position, and steadily retracting cam mechanism lowers power to turn cam and avoids the unpleasant audible “pop” sound of conventional locking assemblies when cam is rotated from the open position to the closed position.

While the invention has been described with reference to the preferred embodiments, it should be understood by those skilled in the art that various changes may be made and equivalents may be substituted for elements thereof without departing from the essential scope of the invention. Therefore, it is intended that the invention not be limited to the particular embodiments disclosed herein contemplated for carrying out this invention, but that the invention will include all embodiments falling within the scope of the claims.

What is claimed is:

1. A retractable noise reduction locking shoe assembly for locking a horizontal or vertical sash window or door within a channel of a frame, comprising:
a slide block having a primary opening extending from a front side of the slide block to a rear side of the slide block, the slide block having opposing side openings being in direct communication with the primary opening, the primary opening from the front side of the side block being defined by at least a partial channel;
a retractable side block having a first end and a second end slidably received within each of the opposing side openings;
a pair of spring members having a first end and a second end oppositely disposed within the partial channel, the first end of the spring member and the second end of the spring member being adapted to receive each retractable side block first end and second end within each of the opposing side openings;
a cam having a front side defined by a perimeter and a rear side defined by a variable diameter having a first end and a second end, the second end configured to receive a pivot member mounted on either the sash window or door, the cam being rotatably disposed within the primary opening and adapted to be rotatable by the pivot member;
wherein rotation of the cam to an open position invokes a portion of the cam rear side other than the first end and the second end of the cam rear side to come into contact with each of the retractable side blocks to urge the retractable side blocks at opposing side openings to expand outwardly from the slide block and lock the slide block within the channel of the window or door frame;
wherein rotation of the cam to a closed position invokes the first end and the second end of the cam rear side to come into contact with each of the retractable side blocks to urge the retractable side blocks at opposing side openings to retract inwardly from the slide block and unlock the slide block within the channel of the window or door frame.

2. The retractable noise reduction locking shoe assembly of claim 1, wherein the slide block is formed by injection molding.

3. The retractable noise reduction locking shoe assembly of claim 1, wherein the retractable side block includes a plurality of serrations.

4. The retractable noise reduction locking shoe assembly of claim 3, wherein the serrations may be comprised of an array of geometric shapes.

5. The retractable noise reduction locking shoe assembly of claim 4, wherein the array of geometric shapes may include squares, circles, triangles, semi-circles, cones, zigzags, or v-shapes, or a combination thereof.

6. The retractable noise reduction locking shoe assembly of claim 1, wherein the retractable side block at each of the opposing side openings forms a plurality of dimples in the channel of the frame when the cam is rotated to the open position.

7. The retractable noise reduction locking shoe assembly of claim 6, wherein the plurality of dimples in the channel of the frame disappear when the cam is rotated to the closed position.

8. The retractable noise reduction locking shoe assembly of claim 1, wherein the first end and the second end of the pair of spring members are connected to the first end and the second end of the retractable side block at each of the opposing side openings.

9. The retractable noise reduction locking shoe assembly of claim 1, wherein rotation of the cam from the open position to the closed position creates an inaudible sound when the sash window or door is opened or closed within the channel of the frame.

10. The retractable noise reduction locking shoe assembly of claim 1, wherein the front side of the cam is flat.

11. The retractable noise reduction locking shoe assembly of claim 1, wherein the front side of the cam has longitudinal ridges disposed thereon.

12. The retractable noise reduction locking shoe assembly of claim 1, wherein the rear side of the cam includes a transverse base having a rectangular opening for receiving the pivot member.

13. The retractable noise reduction locking shoe assembly of claim 1, wherein the front side of the cam is configured to be in operative communication with the channel of the frame when the cam is rotated to the open position.

14. The retractable noise reduction locking shoe assembly of claim 1, wherein the first end and the second end of the cam rear side are separated from each other by no greater than about 180 degrees.

15. The retractable noise reduction locking shoe assembly of claim 1, wherein rotation of the cam by about 15 degrees to about 44 degrees from the closed position to the open position invokes the portion of the cam rear side other than the first end and the second end of the cam rear side to come into contact with each of the retractable side blocks to urge the retractable side blocks at opposing side openings to expand outwardly from the slide block and lock the slide block within the channel of the window or door frame.

16. The retractable noise reduction locking shoe assembly of claim 1, wherein rotation of the cam by about 44 degrees from the open position to the closed position invokes the first end and the second end of the cam rear side to come into contact with each of the retractable side blocks to urge the retractable side blocks at opposing side openings to retract inwardly from the slide block and unlock the slide block within the channel of the window or door frame.

17. The retractable noise reduction locking shoe assembly of claim 1, wherein rotation of the cam from the open position to the closed position invokes the first end and the second end of the cam rear side to come into contact with each of the retractable side blocks to urge the retractable side blocks at opposing side openings to retract inwardly from the slide block by a force of the pair of spring members and unlock the slide block within the channel of the window or door frame.

18. The retractable noise reduction locking shoe assembly of claim 1, wherein rotation of the cam by about 15 degrees to about 44 degrees from the closed position to the open position, the variable diameter of the cam rear side gradually increases from about 17.00 mm to about 18.50 mm.

19. The retractable noise reduction locking shoe assembly of claim 1, wherein rotation of the cam by about 44 degrees to about 15 degrees from the open position to the closed position, the variable diameter of the cam rear side gradually decreases from about 18.50 mm to about 17.00 mm.

20. The retractable noise reduction locking shoe assembly of claim 1, wherein the cam rear side is defined by a perimeter such that the first end and the second end of the cam rear side have a diameter that is less than the diameter of the remaining perimeter of the cam rear side.

21. The retractable noise reduction locking shoe assembly of claim 1, wherein the sash window or door is slidably connected to the frame through at least two retractable noise reduction locking shoes, which slide inside the channel of the frame when the cam is rotated to the closed position.

22. The retractable noise reduction locking shoe assembly of claim 1, wherein the rear side of the slide block includes an upper half portion comprised of a plurality of oppositely disposed protrusions.

23. The retractable noise reduction locking shoe assembly of claim 22, wherein the plurality of oppositely disposed protrusions may be individually ribbed.

24. A retractable noise reduction locking shoe assembly for locking a horizontal or vertical sash window or door within a channel of a frame, comprising:
a slide block having a primary opening extending from a front side of the slide block to a rear side of the slide block, the slide block having opposing side openings being in direct communication with the primary opening, the primary opening from the front side of the side block being defined by at least a partial channel;
a retractable side block having a first end and a second end slidably received within each of the opposing side openings, the retractable side block having serrations comprised of an array of geometric shapes;
a pair of spring members having a first end and a second end oppositely disposed within the partial channel, the first end of the spring member and the second end of the spring member being adapted to receive each retractable side block first end and second end within each of the opposing side openings;
a cam having a front side defined by a perimeter and a rear side defined by a variable diameter having a first end and a second end, the second end configured to receive a pivot member mounted on either the sash window or door, the cam being rotatably disposed within the primary opening and adapted to be rotatable by the pivot member;
wherein rotation of the cam to an open position invokes a portion of the cam rear side other than the first end and the second end of the cam rear side to come into contact with each of the retractable side blocks to urge the retractable side blocks at opposing side openings to expand outwardly from the slide block and lock the slide block within the channel of the window or door frame;
wherein rotation of the cam to a closed position invokes the first end and the second end of cam rear side to come into contact with each of the retractable side blocks to urge the retractable side blocks at opposing side openings to retract inwardly from the slide block and unlock the slide block within the channel of the window or door frame;
wherein rotation of the cam from the open position to the closed position creates an inaudible sound when the sash window or door is opened or closed within the channel of the frame.
